(19) United States
(12) Patent Application Publication
(10) Pub. No.: US 2006/0128591 A1
(43) Pub. Date: Jun. 15, 2006

(54) Detergent-dipped cleaning substrate

(76) Inventors: Harald Albrecht, Hamburg (DE); Petra Koch, Hamburg (DE); Jorg Kuther, Halstenbek (DE); Kathrin Liste, Hamburg (DE)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/523,438

(22) PCT Filed: Jul. 16, 2003
(86) PCT No.: PCT/EP03/07735

§ 371 Date: Sep. 14, 2005

(30) Foreign Application Priority Data
Jul. 27, 2002 (DE) 10234259.8

(51) Int. Cl. C11D 17/00

(52) U.S. Cl. 510/438; 510/295

(57) ABSTRACT

Substrate, which is impregnated with a cleansing preparation with a viscosity from 1 to 3000 mPas, preferably with a viscosity from 1 to 2500 mPas, more preferably with a viscosity from 1 to 2000 mPas, containing a) one or more anionic and/or nonionic surfactants in a concentration from 0.1 to 15% by weight, preferably with a concentration from 1 to 10% by weight; b) water in a concentration from 40 to 99% by weight, preferably in a concentration from 50 to 90% by weight, more preferably in a concentration from 60 to 90% by weight; and c) one or more preservatives in a concentration from 0.01 to 3% by weight, preferably with a concentration from 0.1 to 2% by weight, each based on the total weight of the cleansing preparation.

The present invention relates to cleansing substrates that are impregnated with a well foaming, surfactant-containing cleansing preparation, their production, and use.

The desire for clean skin is probably as old as mankind, because dirt, perspiration, and residues of dead skin particles offer an ideal breeding ground for all kinds pathogens and parasites. The desire for body hygiene continuously intensified, after it had also become possible in the 60's of the twentieth century to formulate liquid cleansers with newly developed synthetic surfactants in addition to “classical” soap. Since then, we can no longer imagine our daily life without taking baths and showers, and currently a large number of products for cleansing the different body parts are available to consumers.

As wash-active substances in cosmetic cleansers, surfactants are of great importance. Because of their specific molecular structure with respectively one hydrophilic (water-attracting) and one hydrophobic (water-repellent) grouping in the same molecule, they see to a reduction of the surface tension of water, wetting of the skin, easier removal of dirt, and foam regulation.

One distinguishes between four classes of surfactants:

A first class includes nonionic surfactants. Among those are fatty alcohol ethoxylates, fatty acid monoethanol amides, and alkyl polyglycosides (APGs).

A second class includes amphoteric surfactants. These are compounds that contain both a cationic function, in most cases a quaternary nitrogen, and an anionic function, in most cases a carboxylate group. Their charge state is pH-dependent. Among those are alkylamino betaines as well as alkylamido glycinates.

The group of the cationic surfactants consists of compounds, which contain at least one quaternary nitrogen atom. Among those are alkyl amines, alkylimidazoles, and ethoxylated amines.

The group of the anionic surfactants is formed from sulfates, sulfonates, and carboxylates, i.e., salts of esters of the sulfuric acid, as well as salts of sulfonic and carboxylic acids, for example, sodium lauryl ether sulfates (sodiumpolyoxyethylene lauryl sulfates).

A special product form for cleansing preparations are solid cleansing substrates, in particular wipes. These can be impregnated already by the manufacturer with the cleansing preparation, and thus have the advantage that they already contain the preparation in the correct dosage. Furthermore, they avoid the disadvantage of preparations stored in bottles, whose packaging may break and whose contents may “leak out.” Further advantages of cleansing substrates/wipes also include the situation that they are easy to take along on trips in counted quantities, and that they normally require no longer water for their application.

Cleansing substrates/wipes are made from textiles. The textiles may be woven or knit, and be present as composite material (nonwoven textile). In most cases, composite materials are used (for cost reasons). In the case of composite materials, the fabric is not produced by warp and weft or stitch formation, but by interlacing, and/or cohesive and/or adhesive bonding of textile fibers. According to DIN 61210 T2, composite materials may be distinguished by nonwoven webs, paper, batting, and felt. Nonwoven webs are loose materials produced from spun fibers (i.e. fibers of a defined length), or filaments (endless fibers), in most cases of polypropylene, polyester, or rayon. Typically, their cohesion is provided by the fibers holding together. In this connection, the individual fibers may have a preferred orientation (oriented or cross-laid webs), or be unoriented (random webs). The nonwovens may be mechanically bonded by needle punching, stitching, or entangling by means of strong water jets. Adhesively bonded nonwovens are produced by gluing the fibers together with liquid binding agents (for example, acrylate polymers, SBR/NBR, polyvinyl ester, polyurethane dispersions), or by melting or dissolving so-called binder fibers that are added to the web during its production. In the case of cohesive bonding, the fiber surfaces are partially dissolved by suitable chemicals and bonded by pressure or fused at an increased temperature [J. Falbe, M. Regnitz: Römpp-Chemie-Lexikon, 9^{th} edition, Thieme-Verlag, Stuttgart (1992)].

Substrates that are impregnated with cosmetic preparations and in particular wipes may be produced in different ways: in a so-called “dip method”, the wipe is immersed into a dip bath or pulled through a bath. This method is especially suited for paper wipes and less suited for nonwoven fabrics, since the latter absorb too much liquid (=preparation), and when being repackaged, subsequently find themselves in puddles of the preparation that has been released again.

A second variant is the “spray method”, wherein the preparation is sprayed onto the advancing fabric. While this method is suitable for all textiles, it does not permit applying heavily foaming preparations to the fabric, since the foam development becomes too great in the spray method.

As further methods, so-called squeegee methods are used, wherein webs of nonwovens or fabric advance along doctor blades, doctor bars, or doctor nozzles, which continuously receive an impregnation solution. Different degrees of impregnation may be adjusted, among other things, by varying the contact pressure and the rate of advance of the fabric.

In the art, it has so far been possible only to a satisfactory extent to apply heavily foaming preparations to paper wipes by the “dip method.” Heavily foaming preparations are primarily used as cleansing preparations, because foam greatly increases their cleansing efficiency. The disadvantage of paper wipes vis-à-vis nonwovens is their low breaking strength. Likewise, nonwovens are substantially softer on the skin and thus more protective. Nonwovens are especially suited for cleansing the face. Last but not least nonwovens are clearly whiter than paper wipes, which makes on consumers a clearly more hygienic impression.

It was therefore an object of the present invention to develop substrates which were intended for impregnation with a heavily foaming cleansing preparation, as well as a method of producing same.

Surprisingly, the object is accomplished by a substrate, which is impregnated with a cleansing preparation having a viscosity of 1 to 3000 mPas, preferably a viscosity of 1 to 2500 mPas, more preferably a viscosity of 1 to 2000 mPas, containing

a) one or more anionic and/or nonionic surfactants in a concentration from 0.1 to 15% by weight, preferably of a concentration from 1 to 10% by weight;

b) water in a concentration from 40 to 99% by weight, preferably in a concentration from 50 to 90% by weight, more preferably in a concentration from 60 to 90% by weight; and

c) one or more preservatives in a concentration from 0.01 to 3% by weight, preferably of a concentration from 0.1 to 2% by weight, each based on the total weight of the cleansing preparation.

The substrates of the invention represent in every respect an extremely satisfactory, well foaming, ready-to-use cleansing utensil, which is usable without a further addition of water. The special mildness of the cleansing preparation makes it possible to use the substrates of the invention for cleansing the skin and/or hair. Its use is possible and advantageous in accordance with the invention even for sensitive and dry skin, for example, the skin of babies, older people, or the skin of the face. The surfactant combination of the preparations according to the invention is so mild that it is no longer necessary to rinse the preparation with water after using the substrate.

In accordance with the invention, it is advantageous, when the concentration of one of more anionic and/or nonionic surfactants is from 0.1 to 15% by weight, preferably 1 to 10% by weight, each based on the total weight of the preparation.

It is furthermore advantageous in accordance with the invention, when water is present in a concentration from 40 to 99% by weight, preferably in a concentration from 50 to 90% by weight, more preferably in a concentration from 60 to 90% by weight based on the total weight of the preparation.

Furthermore, it is advantageous in accordance with the invention, when one or more preservatives are present in a concentration from 0.01 to 3% by weight, preferably with a concentration from 0.1 to 2% by weight, each based on the total weight of the preparation.

In accordance with the invention, it is advantageous, when the cleansing preparation of the invention has a viscosity from 1 to 3000 mPas, preferably a viscosity from 1 to a 2500 mPas, more preferably a viscosity from 1 to 2000 mPas.

In accordance with the invention, it is possible to adjust the viscosity of the cleansing preparation according to the invention advantageously with thickeners, if need be.

It is especially advantageous to select the wash-active surfactant or surfactants of the invention from the group of surfactants, which have an HLB value greater than 25. Especially advantageous are those, which have an HLB value greater than 35.

In accordance with the invention advantageous anionic surfactants for the purposes of the present invention are:

Acylamino acids and salts thereof, such as

acyl glutamates, in particular sodium acyl glutamate
sarcosinates, for example, myristoyl sarcosinate, TEA-lauroyl sarcosinate, sodium lauroyl sarcosinate, and sodium cocoyl sarcosinate;
   Sulfonic acids and salts thereof, such as
acyl isethionates, for example, sodium/ammonium cocoyl isethionate,
sulfosuccinates, for example, dioctyl sodium sulfosuccinate, disodium laureth sulfosuccinate, disodium lauryl sulfosuccinate, and disodium undecylenamido MEA sulfosuccinate;
   as well as sulfuric esters, such as
alkyl ethers sulfates, for example, sodium-, ammonium-, magnesium-, MIPA-, TIPA-laureth sulfate, sodium myreth sulphate, and sodium C₁₂₋₁₃ pareth sulfate,
alkyl sulfates, for example sodium-, ammonium-, and TEA lauryl sulfate.
   In accordance with the invention, it is also possible and advantageous to use
taurates, for example, sodium lauroyl taurate and sodium methyl cocoyl taurate,
ether carboxylic acids, for example, sodium laureth-13 carboxylate and sodium PEG-6 cocamide carboxylate, sodium PEG-7 olive oil carboxylate,
phosphoric acid esters and salts, such as, for example, DEA oleth-10 phosphate and dilaureth-4 phosphate,
alkylsulphonates, for example sodium cocomonoglyceride sulfate, sodium C₁₂₋₁₄ olefin sulfonate, sodium lauryl sulfoacetate, and magnesium PEG-3 cocoamide sulfate.

In accordance with the invention it is preferred to use as anionic surfactants acylamino acid surfactants, sarcosinates, sulfosuccinates, sulfosuccinate citrates, monoalkyl phosphates, and olefin sulfonates.

In accordance with the invention, it is especially preferred to use as anionic surfactants acylamino acid surfactants, such as sodium cocoylglutamate (for example, Aminosoft CS-11 from Ajinomoto), sodiumlauroyl glutamate, sodium capryloyl glutamate, and/or Di-TEA-palmitoyl aspartate.

Advantageous nonionic surfactants for the purposes of the present invention are
alkanolamides, such as cocamides MEA/DEA/MIPA,
esters which are produced by esterification of carboxylic acids with ethylene oxide, glycerol, sorbitol, or other alcohols,
ethers, for example ethoxylated alcohols, ethoxylated lanolin, ethoxylated polysiloxanes, propoxylated POE ethers, and alkyl polyglycosides, such as lauryl glucoside, decyl glycoside and cocoglycoside, and
alcohols.

In accordance with the invention, it is preferred to use as non-ionic surfactants alkylpolyglucosides, with decyl glucoside, lauryl glucoside, cocoglucoside being especially preferred.

It is advantageous in accordance with the invention to select a combination of anionic and non-ionic surfactants, wherein the weight ratio of anionic to non-ionic surfactants is from 2:5 to 5:2. Especially preferred are weight ratios from 5:3 to 3.5:4, and most preferred is 2.5:3 (anionic surfactants to nonionic surfactants).

A particularly preferred form of realization in accordance with the invention is the combination of sodium cocoylglutamate and lauryl- and/or decylglucoside.

The substrates of the invention contain preservatives in the cleansing preparation, with which they are impregnated. Advantageous preservatives for the purposes of the invention are, for example, formaldehyde donors (such as, for example, DMDM hydantoin, which is available under the trade name Glydant™ from Lonza), iodopropyl butylcarbamates (for example, those which are available under the trade names Glycacil-S from Lonza and/or Dekaben LMB from Jan Dekker), parabens (i.e., alkyl esters of the p-hydroxybenzoic acid, such as methyl-, ethyl-, propyl-, and/or butylparaben), phenoxyethanol, ethanol, benzoic acid, and the like. Normally, the preservation system furthermore comprises in accordance with the invention advantageously preservative auxiliaries, such as, for example octoxyglycerin, glycine soya, etc. The following table gives an overview of some preservatives that are advantageous in accordance with the invention.

| | |
|---|---|
| E 200 | Sorbic acid |
| E 201 | Sodium sorbate |
| E 202 | Potassium sorbate |
| E 203 | Calcium sorbate |
| E 210 | Benzoic acid |
| E 211 | Sodium benzoate |
| E 212 | Potassium benzoate |
| E 213 | Calcium benzoate |
| E 214 | Ethyl p-hydroxybenzoate |
| E 215 | Ethyl p-hydroxybenzoate Na salt |
| E 216 | n-Propyl p-hydroxybenzoate |
| E 217 | n-Propyl p-hydroxybenzoate Na salt |
| E 218 | Methyl p-hydroxybenzoate |
| E 219 | Methyl p-hydroxybenzoate Na salt |
| E 220 | Sulfur dioxide |
| E 221 | Sodium sulfite |
| E 222 | Sodium hydrogensulfite |
| E 223 | Sodium disulfite |
| E 224 | Potassium disulfite |
| E 226 | Calcium sulfite |
| E 227 | Calcium hydrogensulfite |
| E 228 | Potassium hydrogensulfite |
| E 230 | Biphenyl (diphenyl) |
| E 231 | Orthophenylphenol |
| E 232 | Sodium orthophenylphenoxide |
| E 233 | Thiabendazole |
| E 235 | Natamycin |
| E 236 | Formic acid |
| E 237 | Sodium formate |
| E 238 | Calcium formate |
| E 239 | Hexamethylenetetramine |
| E 249 | Potassium nitrate |
| E 250 | Sodium nitrite |
| E 251 | Sodium nitrate |
| E 252 | Potassium nitrate |
| E 280 | Propionic acid |
| E 281 | Sodium propionate |
| E 282 | Calcium propionate |
| E 283 | Potassium propionate |
| E 290 | Carbon dioxide |

Also advantageous according to the invention are preservatives or preservative auxiliaries that are customary in cosmetics, such as dibromodicyanobutane (2-bromo-2-bromomethylglutarodinitrile), phenoxyethanol, 3-iodo-2-propynyl butylcarbamate, 2-bromo-2-nitropropane-1,3-diol, imidazolidinyl urea, 5-chloro-2-methyl-4-isothiazolin-3-one, 2-chloroacetamide, benzalkonium chloride, and benzyl alcohol.

According to the invention, it is especially preferred to use as preservatives benzoic acid, and/or salicylic acid, and/or their derivatives, and/or salts of these compounds.

It is furthermore advantageous in accordance with the invention to include in the cleansing preparation of the substrates of the invention additional cosmetic and/or dermatological active ingredients, auxiliaries, and/or additives.

Preferably, besides one or more water phases, the cleansing preparation of the invention can additionally comprise one or more oil phases and. These may be present, for example, in the form of W/O—, O/W—, W/O/W—, or O/W/o emulsions. Such formulations may preferably also be a microemulsion (e.g. a PIT emulsion).

According to the invention, the cleansing preparations of the invention may contain besides the foregoing substances, additives as are customary in cosmetics, for example, perfume, dyes, antimicrobial agents, refatting agents, complexing and sequestering agents, plant extracts, vitamins, active agents, preservatives, bactericides, UV light protection filters, repellents, self-tanners, depigmentors, pigments, which have a coloring effect, softening, moisturizing, and/or humectant substances, or other common constituents of a cosmetic or dermatological formulation, such as emulsifiers, polymers, foam stabilizers, electrolytes, organic solvents, or silicone derivatives.

In accordance with the invention, the cleansing preparation of the invention may advantageously contain as aqueous solution or aqueous phase besides water also other ingredients, for example, alcohols, diols or polyols of a low carbon number, as well as ethers thereof, preferably ethanol, isopropanol, propylene glycol, glycerol, ethylene glycol, ethylene glycol monoethyl- or -monobutyl ether, propylene glycol monomethyl, -monoethyl-, or -monobutyl ether, diethylene glycol monomethyl or -monoethyl ether, and analogous products, furthermore alcohols of a low carbon number, for example, ethanol, isopropanol, 1,2-propanediol, and glycerol.

Advantageous moisturizing or humectant agents (so-called moisturizers) for the purposes of the present invention are, for example, glycerin, lactic acid and/or lactates, in particular, sodium lactate, butylene glycol, propylene glycol, biosaccharide gum-1, glycine soya, ethylhexyloxyglycerin, pyrrolidone carboxylic acid, and urea. Furthermore, it is of special advantage to use polymeric moisturizers from the group of the water-soluble and/or water-swellable and/or water-gellable polysaccarides. Particularly advantageous are, for example, hyaluronic acid, chitosan, and/or a fucose-rich polysaccharide, which is filed in the Chemical Abstracts under the Registry Number 178463-23-5, and which can be obtained, for example, under the name Fucogel™ 1000 from SOLABIA S.A.

In accordance with the invention, it is advantageous to add film formers (conditioners) to the cleansing preparations of the invention.

Advantageous water-soluble or dispersible film formers are, for example, polyurethane (for example, the Avalure® types from Goodrich), dimethicone copolyol polyacrylate (Silsoft Surface® from Witco Organo Silicones Group) PVP/VA (VA=vinyl acetate) copolymer (Luvisol VA 64 Powder from BASF), etc.

Advantageous fat-soluble film formers are, for example, the film formers from the group of the polymers on the basis of polyvinylpyrrolidone (PVP)

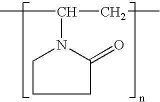

Advantageous are the copolymers of polyvinyl pyrrolidone, for example, the PVP of hexadecene copolymer, and the PVP eicosen copolymer, which are available under the tradenames Antaron V216 and Antaron V220 from GAF Chemicals Corporation, as well as tricontayl PVP, and the like.

Suitable as film formers with at least one partially quaternized nitrogen group are preferably those which are selected from the group of the substances that bear the name “polyquaternium” in accordance with the INCI Nomenclature (International Nomenclature Cosmetic Ingredient), for example:
Polyquaternium-2 (Chemical Abstracts No. 63451-27-4 for example, Mirapol® A-15)
Polyquaternium-5 (Copolymers from acrylamide, β-methacryloxyethyltriethyl ammoniummethosulfate, CAS No. 26006-22-4)
Polyquaternium-6 Homopolymer of N,N-dimethyl-N-2-propenyl-2-propen-1-aminium chloride, CAS No. 26062-79-3, for example, Merquat® 100
Polyquaternium-7 N,N-Dimethyl-N-2-propenyl-2-propen aminium chloride, polymers with 2-propenamide, CAS No. 26590-05-6, for example, Merquat® S
Polyquaternium-10 Quaternary ammonium salt of hydroxyethyl cellulose, CAS Nos. 53568-66-4, 55353-19-0, 54351-50-7, 68610-92-4, 81859-24-7, for example, Celquat® SC-230M
Polyquaternium-11 Vinylpyrrolidone/dimethyl aminoethyl-methacrylate copolymer/diethylsulfate reaction product, CAS No. 53633-54-8, for example, Gafquat®755N
Polyquaternium-16 Vinylpyrrolidone/vinylimi-dazolinium methochloride copolymer, CAS No. 29297-55-0, for example, Luviquat® HM552
Polyquaternium-17 CAS No. 90624-75-2, for example, Mirapol®AD-1
Polyquaternium-19 Quaternized water-soluble polyvinyl alcohol
Polyquaternium-20 Water-dispersible, quaternized polyvinyl octadecyl ether
Polyquaternium-21 Polysiloxane-polydimethyl-dimethylammonium acetate copolymers for example, Abil® B 9905
Polyquaternium-22 Dimethyldiallyl ammonium chloride/acrylic acid copolymer, CAS No. 53694-7-0, for example, Merquat®280
Polyquaternium-24 Polymeric quaternary ammonium salt of the hydroxyethyl cellulose, reaction product with a lauryl dimethyl ammonium-substituted epoxide, CAS No. 107987-23-5, for example, Quatrisoft® LM-200
Polyquaternium-28 Vinylpyrrolidone/methacryl-amidopropyl-trimethyl ammonium chloride copolymer, for example, Gafquat®HS-100
Polyquaternium-29 for example, Lexquat® CH
Polyquaternium-31 CAS No. 136505-O₂-7, for example, Hypan® QT 100
Polyquaternium-32 N,N,N-trimethyl-2-[(2-methyl-1-oxo-2-propenyl)oxy]-ethanaminium chloride, polymer with 2-propenamide, CAS No. 35429-19-7
Polyquaternium-37 CAS No. 26161-33-1
Polyquaternium-44 Copolymeric quaternary ammonium salt consisting of vinylpyrrolidone and quaternized imidazoline, for example, Luviquat Care®

Preferred and advantageous are the polymers Polyquaternium-10, Polyquaternium-22, and Polyquaternium-44.

A particularly preferred film former in accordance with the invention is Polyquaternium-10 (Ucare Polymer JR-125®, Ucare Polymer JR-400® from Amerchol).

Further advantageous film formers are quaternized guar gum derivatives, such as, for example, guar hydroxypropyl trimonium chloride (Jaguar Excel®, Jaguar C 162® from Rhodia), and/or cellulose derivatives.

The oil phase of the cleansing preparations according to the invention is advantageously chosen from the group of polar oils, for example from the group of lecithins and of fatty acid triglycerides, namely the triglycerol esters of saturated and/or unsaturated, branched and/or unbranched alkanecarboxylic acids of a chain length from 8 to 24, in particular 12 to 18 carbon atoms. The fatty acid triglycerides can, for example, advantageously be chosen from the group of synthetic, semi-synthetic and natural oils, such as, for example, cocoglyceride, olive oil, sunflower oil, soya oil, peanut oil, rapeseed oil, almond oil, palm oil, coconut oil, castor oil, wheatgerm oil, grapeseed oil, thistle oil, evening primrose oil, macadamia nut oil, and the like.

Further advantageous polar oil components can also be chosen for the purposes of the present invention from the group of esters of saturated and/or unsaturated, branched and/or unbranched alkanecarboxylic acids of a chain length from 3 to 30 carbon atoms and saturated and/or unsaturated, branched and/or unbranched alcohols of a chain length from 3 to 30 carbon atoms, and from the group of esters of aromatic carboxylic acids and saturated and/or unsaturated, branched and/or unbranched alcohols of a chain length from 3 to 30 carbon atoms. Such ester oils can then advantageously be chosen from the group consisting of octyl palmitate, octyl cocoate, octyl isostearate, octyl dodecyl myristate, octyldodecanol, cetearyl isononoanoate, isopropyl myristate, isopropyl palmitate, isopropyl stearate, isopropyl oleate, n-butyl stearate, n-hexyl laurate, n-decyl oleate, isocotyl stearate, isnonyl stearate, isononyl isononanoate, 2-ethylhexyl palmitate, 2-ethyhexyl laurate, 2-hexyldecyl stearate, 2-octyldodecyl palmitate, stearyl heptanoate, oleyl oleate, oleyl erucate, erucyl oleate, erucyl erucate, tridecyl stearate, tridecyl trimellitate, and synthetic, semisynthetic, and natural mixtures of such esters, such as, for example, jojoba oil.

In addition, the oil phase can advantageously be chosen from the group of dialkyl ethers and dialkyl carbonates, for example dicaprylyl ether (Cetiol OE) and/or dicaprylyl carbonate, for example that available under the trade name Cetiol CC from Cognis.

It is also preferred to choose the oil component or components from the group consisting of isoeicosane, neopentyl glycol diheptanoate, propylene glycol dicaprylate/dicaprate, caprylic/capric/diglyceride succinate, butylene glycol dicaprylate/dicaprate, cocoglycerides (e.g. Myritol® 331 from Henkel), C₁₂₋₁₃ alkyl lactate, di-C₁₂₋₁₃ alkyl tartrate, triisostearin, dipentaerythrityl hexcaprylate/hexacaprate, propylene glycol monoiostearate, tricaprylin, dimethyl isosorbide. It is particularly advantageous, when the oil phase of the formulations according to the invention has a content of C₁₂₋₁₅-alkyl benzoate or consists entirely of this.

Advantageous oil components are also, for example, butyloctyl salicylate (for example that available under the trade name Hallbrite BHB from CP Hall), hexadecyl benzoate and butyloctyl benzoate and mixtures thereof (Hallstar AB) and/or diethylhexyl naphthalate (Corapan® TQ from Haarmann & Reimer).

In accordance with the invention, it is also advantageous to use as oil component paraffinum liquidum.

In accordance with the invention, advantageous embodiments of the substrates according to the invention are characterized in that the cleansing preparation contains skin-caring oils and/or emulsions. According to the invention, the cleansing preparation preferably contains skin-caring oils and/or emulsions in concentrations smaller than 0.5% by weight.

The substrates of the invention may be smooth or surface-structured. According to the invention, surface-structured substrates are preferred.

According to the invention, it is preferred to use substrates in the form of wipes, which consist of a nonwoven fabric, in particular water-jet-bonded and/or water-jet-embossed nonwovens. Advantageously, the substrates may also be realized as bulk material, perforated nonwoven, or mesh fabric.

Textiles of this type may have macro embossed surfaces of any desired pattern. The selection to be made depends on the one hand on the impregnation being applied, and on the other hand on the field of application, in which the subsequent wipe is to be used.

If embossed nonwovens are to be used, large cavities on the surface of the nonwoven and in the nonwoven will facilitate absorption of dirt and impurities, when the impregnated wipe is moved over the skin. In comparison with smooth wipes, it is possible to increase the cleansing effect by a multiple.

It has been found advantageous for the wipe, when same has a weight of 20 to 120 g/m², preferably 30 to 80 g/m², more preferably 40 to 60 g/m² (measured at 20° C.±2° C. and at a humidity of the room air of 65%±5% for 24 hours).

The thickness of the nonwoven is preferably from 0.2 mm to 2 mm, in particular 0.4 mm to 1.5 mm, preferably 0.6 mm to 0.9 mm.

As basic materials for the nonwoven fabric of the wipe, it is possible to use in general all organic and inorganic fiber materials on natural and synthetic basis. Examples include cellulose, jute, hemp, sisal, silk, wool, polypropylene, polyethylene therephthalate (PET), aramid, nylon, polyvinyl derivatives, polyurethane, polylactide, polyhydroxy alkanoate, cellulose ester and/or polyethylene, as well as mineral fibers, such as glass fibers or carbon fibers. The present invention, however, is not limited to the referenced materials. It is also possible to use a plurality of further fibers for constructing the nonwoven. It is especially advantageous for the purposes of the present invention when the used fibers are water-insoluble.

In an advantageous embodiment of the nonwoven, the fibers consist of a blend of 60% to 80% rayon, with 40% to 20% PET, in particular 70% rayon and 30% PET. Especially advantageous is a blend of 70% viscose and 30% PET.

Especially advantageous are also fibers of high-tenacity polymers, such as polyamide, polyester and/or highly oriented polyethylene.

Moreover, the fibers may also be dyed to be able to highlight and/or enhance the optical attractiveness of the nonwoven. The fibers may contain in addition UV stabilizers and/or preservatives.

The fibers used for producing the fabric preferably have a water absorption rate of more than 60 mm/[10 min.] (measured by the EDANA test 10.1-72), in particular more than 80 mm/[10 min.].

Furthermore, the fibers used for producing the fabric preferably have a water absorption capacity of more than 5 g/g (measured by the EDANA test 10.1-72), in particular more than 8 g/g.

Advantageous fabrics for the purposes of the present invention have a tensile strength, in particular

| | | [N/50 mm] |
|---|---|---|
| in the dry state | machine direction | >60, preferably >80 |
| | cross direction | >20, preferably >30 |
| in the impregnated | machine direction | >4, preferably >60 |
| state | cross direction | >10, preferably >20 |

The elongation of the advantageous fabric is preferably

| | | |
|---|---|---|
| in the dry state | machine direction | 15% to 100%, |
| preferably | | 20% and 50% |
| | cross direction | 40% to 120%, |
| preferably | | 50% and 85% |
| in the impregnated | machine direction | 15% to 100%, |
| state | | |
| preferably | | 20% and 40% |
| | cross direction | 40% to 120%, |
| preferably | | 50% and 85% |

In accordance with the invention, the weight ratio of nonwoven to cleansing substrate is preferably in a range from 1:0.5 to 1:5. Especially preferred is a range from 1:0.7 to 1:3.

According to the invention, the method relates to the production of the substrates according to the invention.

The substrates of the invention can be advantageously produced in accordance with the invention by using the method of:

a) Direct coating
The impregnation solution is continuously supplied to a scraper arrangement (scraper bar, counterrotating roller system, or the like), and transferred by contact to a moving substrate.

b) Spray coating
The liquid impregnation solution is sprayed onto the moving substrate.

c) Dip coating
The fabric material passes through a bath filled with the liquid impregnation solution, or an entire roll of fabric is immersed into the impregnation solution.

The production examples are intended to illustrate the present invention without limiting it.

Likewise in accordance with the invention is the use of the fabric according to the invention as cosmetic wipe for the cleansing and care of the skin and/or hair. In particular, it is in accordance with the invention to use the fabric for cleansing the face or for “removing” decorative cosmetics. The fabric of the invention can be used in particular for cleansing sensitive skin, for example, dry skin, the skin of babies or older people.

It is likewise in accordance with the invention to use the fabric of the invention as a mild, foaming cleansing utensil.

The following examples are intended to illustrate the present invention, without limiting it. Unless otherwise specified, all quantity, constituent, and percentage values are based on the weight and the total quantity or total weight of the preparations.

### Examples for Impregnation Solutions

| | 1 | 2 | 3 | 4 | 5 |
|---|---|---|---|---|---|
| Sodium cocoyl glutamate | 3.5 | — | — | — | 5 |
| Sodium laurylether | — | 5 | — | — | — |
| sulfate | | | | | |
| Sodium lauroyl | — | — | 3.5 | — | — |
| sarcosinate | | | | | |
| Sodium lauroyl | — | — | — | 5 | — |
| sulfosuccinate | | | | | |
| Decylglucoside | 4 | 3 | — | — | 6 |
| Laurylglucoside | — | — | 4 | 3 | — |
| Polyquaternium-10 | 0.1 | — | — | 0.1 | 0.1 |
| Guar Hydroxypropyl- | — | 0.15 | — | — | — |
| trimonium chloride | | | | | |
| Polyquaternium-22 | — | — | 0.2 | — | — |
| Polyquaternium-44 | — | — | — | — | 0.1 |
| PEG-200 hydrogenated | 0.5 | — | — | — | — |
| glyceryl palmitate | | | | | |
| PEG-40 hydrogenated | 0.1 | 0.1 | 0.1 | 0.1 | 0.1 |
| castor oil | | | | | |
| PEG-100 hydrogentated | — | 0.5 | — | 0.5 | — |
| glyceryl palmitate | | | | | |
| Sodium benzoate | 0.5 | 0.5 | — | 0.5 | 0.5 |
| Sodium salicylate | — | 0.2 | — | 0.2 | 0.2 |
| Methyldibromoglutaroni- | — | — | 0.04 | — | |
| trile | | | | | |
| Phenoxyethanol | — | — | 0.16 | — | — |
| Parabens | — | — | 0.50 | — | — |
| Jojoba oil (Buxus | 0.1 | — | — | — | — |
| Chinensis) | | | | | |
| Paraffinum liquidum | — | — | — | 0.1 | — |
| Citric acid | q.s. | q.s. | q.s. | q.s. | q.s. |
| Perfume | q.s. | q.s. | q.s. | q.s. | q.s. |
| Water | ad 100 | ad 100 | ad 100 | ad 100 | ad 100 |

| | 6 | 7 |
|---|---|---|
| Sodium cocoyl glutamate | 2.5 | 2.5 |
| Sodium laurylether sulfate | — | — |
| Sodium lauroyl sarcosinate | — | — |
| Sodium lauroyl sulfosuccinate | — | — |
| Decylglucoside | 4 | — |
| Laurylglucoside | — | 5 |
| Polyquaternium-10 | — | — |
| Paraffinum liquidum | 0.5 | 8.0 |
| Glycerin | 7.0 | 5.0 |
| Octyl stearate | 1.0 | 2.0 |
| Glyceryl stearate, ceteareth-20, ceteareth-12, | 3.0 | 1.5 |
| cetearyl alcohol, cetyl palmitate | | |
| Phenoxyethanol, methyl paraben, ethyl para- | 0.5 | 0.5 |
| ben, propyl paraben, butyl paraben, isobutyl | | |
| paraben | | |
| Perfume | 2.0 | 0.4 |
| Ceteareth-20 | 10.0 | 0.3 |
| Methyl paraben | 1.0 | 0.3 |
| Water | ad 100 | ad 100 |

1. A substrate impregnated with a cleansing preparation, the cleansing preparation comprising
a) one or more surfactants selected from the group consisting of anionic and nonionic surfactants in a concentration from 0.1 to 15% by weight,
b) water in a concentration from 40 to 99% by weight; and
c) one or more preservatives in a concentration from 0.01 to 3% by weight, each based on the total weight of the cleansing preparation,
wherein the cleansing preparation has a viscosity from 1 to 3000 mPa·s.

2. A substrate as claimed in claim 1, wherein the substrate is present in the form of a wipe.

3. A substrate as claimed in claim 1, wherein the one or more surfactants includes at least one anionic surfactant selected from the group consisting of acylamino acid surfactants, sarcosinates, sulfosuccinates, sulfosuccinate citrates, monoalkyl phosphates, and olefin sulfonates.

4. A substrate as claimed in claim 1, wherein the one or more surfactants includes at least one nonionic surfactant selected from the group consisting of alkyl polyglycosides.

5. A substrate as claimed in claim 1, wherein the one or more preservatives includes at least one preservative selected from the group consisting of benzoic acid, salicylic acid, derivatives and salts of benzoic acid, and derivatives and salts of salicylic acid.

6. A substrate as claimed in claim 1, wherein the one or more surfactants includes at least one anionic surfactant and at least one nonionic surfactant, wherein the weight ratio of the at least one anionic surfactant to the at least one nonionic surfactant is from 2:5 to 5:2.

7. A substrate as claimed in claim 1, wherein the weight ratio of substrate to cleansing preparation is from 1:0.5 to 1:5.

8. A substrate as claimed in claim 1, wherein the cleansing preparation is applied to the substrate by a spreading method, spraying method, dipping method, or method combining at least two methods selected from spreading, spraying, and dipping.

9. A method for the cleansing or the care of the skin or hair comprising contacting a substrate with the skin or hair, wherein the substrate is impregnated with a cleansing preparation comprising:
a) one or more surfactants selected from the group consisting of anionic and nonionic surfactants, in a concentration from 0.1 to 15% by weight;
b) water in a concentration from 40 to 99% by weight; and
c) one or more preservatives in a concentration from 0.01 to 3% by weight; each based on the total weight of the cleansing preparation.

10. A mild, foaming cleansing utensil comiprising the substrate as claimed in claim 1.

11. The substrate as claimed in claim 1, wherein the cleansing preparation has a viscosity from 1 to 2500 mPa-s.

12. The substrate as claimed in claim 1, wherein the cleansing preparation has a viscosity from 1 to 2000 mPa·s.

13. The substrate as claimed in claim 1, wherein the one or more surfactants is present in a concentration from 1 to 10% by weight, based on the total weight of the cleansing preparation.

14. The substrate as claimed in claim 1, wherein water is present in a concentration from 50 to 90% by weight, based on the total weight of the cleansing preparation.

15. The substrate as claimed in claim 1, wherein the water is present in a concentration from 60 to 90% by weight, based on the total weight of the cleansing preparation.

16. The substrate as claimed in claim 1, wherein the one or more preservatives is present in a concentration from 0.1 to 2% by weight, based on the total weight of the cleansing preparation.

17. The substrate as claimed in claim 6, wherein the weight ratio of the at least one anionic surfactant to the at least one nonionic surfactant is from 3.5:4 to 5:3.

18. The method as claimed in claim 9, wherein the one or more surfactants includes at least one anionic surfactant and at least one nonionic surfactant, wherein the weight ratio of the at least one anionic surfactant to the at least one nonionic surfactant is from 2:5 to 5:2.

19. The method as claimed in claim 9, wherein the one or more surfactants includes at least one anionic surfactant selected from the group consisting of acylamino acid surfactants, sarcosinates, sulfosuccinates, sulfosuccinate citrates, monoalkyl phosphates, and olefin sulfonates.

20. The method as claimed in claim 9, wherein the one or more surfactants includes at least one nonionic surfactant selected from the group consisting of alkyl polyglycosides.
